(19) United States
(12) Patent Application Publication
(10) Pub. No.: US 2019/0016894 A1
(43) Pub. Date: Jan. 17, 2019

(54) METHOD FOR PREPARING A SOLID BITUMEN MATERIAL AT AMBIENT TEMPERATURE

(71) Applicants: TOTAL MARKETING SERVICES, Puteaux (FR); CENTRE NATIONAL DE LA RECHERCHE SCIENTIFIQUE, Paris (FR)

(72) Inventors: Pauline ANACLET, Lyon (FR); Yvong HUNG, Lyon (FR); Rénal BACKOV, Bordeaux-Cauderan (FR); Véronique SCHMITT, Talence (FR)

(73) Assignees: TOTAL MARKETING SERVICES, Puteaux (FR); CENTRE NATIONAL DE LA RECHERCHE SCIENTIFIQUE, Paris (FR)

(21) Appl. No.: 16/065,218

(22) PCT Filed: Dec. 21, 2016
(86) PCT No.: PCT/FR2016/053598

§ 371 Date: Jun. 22, 2018

(30) Foreign Application Priority Data
Dec. 22, 2015 (FR) 1563105

(51) Int. Cl. C08L 95/00; C08K 3/36; C10C 3/14

(52) U.S. Cl. CPC C08L 95/00; C08K 3/36; C08L 2555/24; C08L 2555/52; C08L 2555/22; C10C 3/14

(57) ABSTRACT

A method for preparing a solid bitumen material at ambient temperature, said method comprising at least the steps of: a) preparing an emulsion of bitumen drops in a water phase; b) preparing a silica sol or silica gel from a silicon oxide precursor that has a pH of 4 to 8; c) bringing the emulsion of bitumen drops from step a) into contact with the silica sol or silica gel from step b); d) subjecting the bitumen suspension from step c) to an atomization treatment.

The present invention lies in the technical field of bitumens. More specifically, the invention relates to a process for obtaining bitumen in divided form, which is solid at ambient temperature, and to the material thus obtained.

The present invention also relates to a process for producing bituminous mixes from solid bitumen according to the invention and also to a process for transporting and/or storing road bitumen which is solid at ambient temperature according to the invention.

### PRIOR ART

Bitumen is a material used in very large quantities as a construction material. Combined with aggregates, fines or reinforcements, bitumen is used for example for the production of road carriageways and leakproofing coverings on roofs or in holding tanks. Bitumen is generally in the form of a black material which has a high viscosity, or is even solid at ambient temperature, and which becomes fluid by heating.

In general, bitumen is stored and transported hot, in bulk, in tanker trucks or by boat at high temperatures of about 120° C. to 160° C. However, hot bitumen storage and transportation of have some drawbacks. Firstly, the transportation of hot bitumen in liquid form is considered to be dangerous and highly subject to regulatory control. This mode of transport does not present particular difficulties when the transportation equipment and infrastructure are in good condition. If this is not the case, it can become problematic: if the tanker truck is not sufficiently insulated, the viscosity of the bitumen may increase during an excessively long journey. Bitumen delivery distances are therefore limited. Secondly, maintaining bitumen at high temperatures in tanks or in tanker trucks consumes energy. In addition, maintaining bitumen at high temperatures for a long period of time can affect the properties of the bitumen and thus change the final performance levels of the bituminous mix.

In order to solve this problem, it has been envisioned to disperse the bitumen in the form of an emulsion, the viscosity of which is lower than that of bitumen. However, this emulsifying involves a high water content which is not advantageous for transportation. It is difficult to concentrate the bitumen in emulsions above 80%.

In order to overcome the problems of hot bitumen transportation and storage, packagings allowing bitumen transportation and storage at ambient temperature have been developed. This mode of bitumen transportation by packaging at ambient temperature represents only a minimal fraction of the amounts transported throughout the world, but it corresponds to very real needs for geographical regions which are difficult and expensive to access by the conventional transportation means.

By way of example of packaging allowing the cold transportation currently used, mention may be made of the packaging of the bitumen at ambient temperature in metal drums. This means is increasingly questionable from an environmental point of view because the bitumen stored in the drums must be reheated before it is used as a road binder. However, this operation is difficult to implement for this type of packaging and the drums constitute a waste after use. Furthermore, the storage of bitumen at ambient temperature in drums results in losses because the bitumen is very viscous and a portion of the product remains on the walls of the drum when it is transferred into the tanks of the bituminous mix production units. With regard to the handling and the transportation of bituminous products in these drums, they can prove to be difficult and dangerous if the specialized equipment for handling the drums is not available from the transporters or at the site where the bitumen is used.

By way of other examples of packaging, mention may be made of bitumens in the form of granules transported and/or stored in bags, often used in places where the ambient temperature is high. These granules have the advantage of being easy to handle. U.S. Pat. No. 3,026,568 describes bitumen granules covered with a powdery material, such as limestone powder. Nevertheless, this type of bitumen in granules does not prevent the creep of the bitumen, in particular at high ambient temperature.

Application WO 2009/153324 describes bitumen granules coated with a polymeric anti-agglomerating compound, in particular polyethylene. The drawback of this coating is that it modifies the properties of the bitumen when it is used on roads.

American patent U.S. Pat. No. 5,637,350 describes a bitumen in the form of prills in which the bitumen is encapsulated in a water-impermeable and water-insoluble shell. The bitumen prills are obtained by vaporizing the bitumen in the molten state so as to form drops, and then by coating these drops with a water-impermeable and water-insoluble coating.

Mention may also be made of American patent U.S. Pat. No. 8,404,164 describing a composition of bitumen in the form of solid pellets. These bitumen pellets are obtained by mixing the liquid bitumen with a thickening compound and then a hardening compound, with passage through a granulator. Once in solid form, the bitumen can advantageously be transported at ambient temperature without particular precautions, for example in bags.

An additional difficulty lies in the fact that it is desirable to be able to transport bitumen in solid form even when the outside temperature is very high.

Document WO 2015/104518 describes a process for obtaining a solid bitumen material, which consists in preparing an emulsion of bitumen drops in an aqueous phase stabilized with a mixture of at least two types of solid particles, optionally in forming a shell around the bitumen drops, then in drying the suspension. This process optionally comprises the formation of a silicon oxide-based shell around the bitumen drops, this shell resulting from the reaction of a silicon oxide precursor in an acidic aqueous medium so as to form a gel around the bitumen drops. The pH values used for carrying out this step are generally less than 1, the condensation reaction being promoted by pH values far from the isoelectric point of silica, which is 2.1.

Moreover, American patent application US 2012/0128747 has described a material in the form of solid particles consisting of a continuous shell comprising silicon oxide, containing a core comprising at least one crystallizable oil having a melting point below 100° C. These particles are designed to enable the encapsulation of one or more molecules of interest and the controlled release thereof. Likewise in this document, very low pH values are used to carry out the encapsulation. Moreover, a bitumen composition is much more complex than a crystallizable oil. The extrapolation of operating conditions known to work on the encapsulation of crystallizable oils does not give satisfactory results on all bitumen compositions.

Document JP 2004 091761 describes a bitumen emulsion comprising an emulsifying agent and a colloidal silica, the function of which is to reduce the tacky nature of the bitumen after application. This document does not teach the formation of granules of solid bitumen.

U.S. Pat. No. 1,738,776 describes aqueous dispersions of bitumen having improved stability through the addition of a silica gel, which is used in addition to the conventional stabilizers such as clays. This document does not relate to a process for preparing a bitumen material which is solid at ambient temperature.

U.S. Pat. No. 5,382,348 describes a process for preparing bitumen granules, this process comprising the spraying of the hot liquid bitumen in the presence of a separating agent which may be silica.

The conditions used for the formation of a silicon oxide-based shell in the prior art processes are very acidic conditions throughout said processes. However, the use of such acidic conditions throughout the steps of the processes in the industrial field is not advised because of the problems associated with the corrosion of the industrial equipment and also the risks run by users, for instance acid burns, acid vapours, etc.

The objective of the invention is to overcome these problems and to provide a process which makes it possible, starting from a bitumen emulsion, to form a silicon oxide-based shell around the bitumen drops, regardless of the nature of the bitumen emulsion.

More specifically, the objective of the invention is to provide an economical industrial process which is friendly to the industrial equipment and the users thereof, making it possible, starting from a bitumen emulsion, to form a silicon oxide-based shell around the drops of bitumen, regardless of the nature of the bitumen emulsion.

### SUMMARY OF THE INVENTION

The invention relates to a process for preparing a bitumen material which is solid at ambient temperature, this process comprising at least the steps consisting in:
a) preparing an emulsion of bitumen drops in an aqueous phase,
b) preparing a silica sol or a silica gel from a first silicon oxide precursor at a pH ranging from 4 to 8,
c) bringing the emulsion of bitumen drops from step a) into contact with the silica sol or silica gel from step b),
d) subjecting the bitumen suspension resulting from step c) to a spray-drying treatment.

Advantageously, this process relates to the production of bitumen granules which are solid at ambient temperature.

According to one preferred embodiment, the silicon oxide precursor is chosen from silicates.

According to a more preferred embodiment, the silicon oxide precursor is chosen from the group made up of sodium silicate, magnesium silicate, iron silicate, calcium silicate, potassium silicate, and mixtures thereof.

According to one preferred embodiment, the bitumen emulsion in step a) is a stabilized emulsion of bitumen drops in an aqueous phase.

According to a more preferred embodiment, the bitumen emulsion in step a) is stabilized with a surfactant or a mixture of surfactants chosen from amphoteric, nonionic, anionic and cationic surfactants.

According to an advantageous embodiment, the bitumen emulsion from step a) is stabilized with a cationic surfactant chosen from: a salt of an amine compound chosen from alkylamine salts; polyamine salts; polyamidoamine salts; alkylamidopolyamine salts; alkylpropylenepolyamine salts; imidazoline salts; quaternary ammonium salts; and mixtures thereof.

According to one preferred embodiment, the drops of the bitumen emulsion from step a) have a diameter ranging from 1 pm to 100 μm, preferably from 1 μm to 70 μm, more preferentially from 1 μm to 50 μm.

According to one preferred embodiment, in step b), the pH of the aqueous phase is adjusted to a value ranging from 5 to 7.

According to one preferred embodiment, in step c), the pH of the aqueous phase has a value ranging from 5 to 7.

According to one preferred embodiment, the bitumen from step a) comprises less than 1.4% of solid particles by weight relative to the total weight of bitumen base.

Another subject of the invention is a solid bitumen material that can be obtained by means of the process as described above, this material being in the form of particles comprising a core and a coating layer, in which:
the core comprises at least one bitumen base,
the coating layer is silica-based, and
the core comprises less than 1.4% of solid particles by weight relative to the 40 total weight of bitumen base.

According to one preferred embodiment, the material is in powder form.

According to one preferred embodiment, the material comprises from 5% to 35% by weight of silica relative to the total weight of the material, preferably from 5% to 30%, more preferentially from 10% to 25%.

The invention further relates to the use of solid bitumen as described above, as a road binder.

According to one preferred embodiment, this use is for the production of bituminous mixes.

Another subject of the invention is a process for producing bituminous mixes comprising at least one road binder and aggregates, the road binder being chosen from the solid bitumens as described above, this process comprising at least the steps of:
heating the aggregates to a temperature ranging from 100° C. to 180° C., preferably from 120° C. to 160° C.,
mixing the aggregates with the road binder;
obtaining bituminous mixes.

According to one preferred embodiment, the process for producing bituminous mixes does not comprise a step of heating the road binder before it is mixed with the aggregates.

A subject of the invention is also a process for transporting and/or storing road bitumen, said road bitumen being transported and/or stored in the form of bitumen which is solid at ambient temperature as described above,

The process of the invention has many advantages: it is simple to implement, in particular industrially, it is applicable to any type of bitumen emulsion, in particular to emulsions stabilized with surfactants and not comprising particles to allow their stabilization, it results, in few steps, in a material which is solid and in the form of finely divided particles, the particle size being adjustable by means of the parameters of the process.

The material obtained by means of the process of the invention has the following advantages: it is thermally stable, in particular at high temperatures, and advantageously for a temperature ranging up to 100° C. The solid bitumen material of the invention does not adhere and has good flowability, which facilitates its handling for loading and/or unloading thereof, during the transportation, storage and/or use thereof. The solid bitumen material according to the invention at high temperature and under mechanical shear can be easily released in liquid form at the working temperatures for said material. The term “working temperature” is intended to mean temperatures of between 100° C. and 180° C., preferably between 120° C. and 160° C., more preferentially between 140° C. and 160° C. The solid bitumen material can thus, once transported, be returned, by heating, to a liquid form suitable for use thereof and 40 the properties of which are not modified, Advantageously, the release of the solid bitumen composition according to the invention is carried out by bringing it into contact with hot aggregates under mechanical shear, without performing prior heating of the solid bitumen composition.

### DETAILED DESCRIPTION

The objectives that the applicant set itself have been achieved by virtue of the development of compositions of bitumen in a divided form, which is solid at ambient temperature, having a core/shell structure in which the core is bitumen-based and the coating layer confers, on the overall structure, improved properties compared with the bitumen granules known from the prior art.

The term “ambient temperature” is intended to mean the temperature resulting from the climatic conditions in which the road bitumen is transported and/or stored. More specifically, the ambient temperature is equivalent to the temperature reached during the transportation and/or storage of the road bitumen, it being understood that the ambient temperature implies that no introduction of heat is carried out, other than that resulting from the climatic conditions.

The invention relates to bitumens that may be subjected to a high ambient temperature, in particular a temperature of less than 100° C., preferably from 20° C. to 80° C.

In the present invention, the term “solid” denotes, at the macroscopic level, the quality of a material having a shape and a specific volume.

The term “bitumen which is solid at ambient temperature” is intended to mean a bitumen which has a solid appearance at ambient temperature regardless of the transportation and/or storage conditions. More specifically, the term “bitumen which is solid at ambient temperature” is intended to mean a bitumen which retains its solid appearance throughout the transportation and/or storage at ambient temperature, that is to say a bitumen which does not creep at ambient temperature under its own weight and, furthermore, which does not creep when it is subjected to pressure forces resulting from the transportation and/or storage conditions.

The term “solid bitumen material” is intended to mean, for example, powders, granules, particles, wafers or granular pastes of bitumen.

For the purposes of the present invention, the term “mineralizing” is intended to mean a treatment with a silica sol or gel under conditions which make it possible to form an at least partial, silicon oxide-based, coating around the bitumen drops in emulsion.

The invention relates firstly to a process for preparing a bitumen material which is solid at ambient temperature, this process using an emulsion of bitumen in the aqueous phase.

The process of the invention comprises firstly two steps, the preparation of an emulsion of bitumen in the aqueous phase, so as to form bitumen drops and the preparation of a silica sol or a silica gel in the substantially neutral aqueous phase, so as to form a shell comprising silicon oxide around the bitumen drops. The term “substantially neutral aqueous phase” is intended to mean, for the purposes of the invention, an aqueous phase having a pH ranging from 4 to 8, advantageously a pH ranging from 5 to 7. The shell is preferably an essentially inorganic shell of silicon oxide.

This latter step is based on a synthesis of silicon oxide via the sol-gel route. This route comprises the preparation of a sol containing at least one silicon oxide precursor, the hydrolysis and the condensation of these precursors at substantially neutral pH, and then a step of maturation resulting in the formation of a gel.

The process of the invention comprises secondly a step of bringing into contact, in the substantially neutral aqueous phase, the emulsion of bitumen and the silica sol or gel previously prepared.

Without being bound by theory, the applicant has noted that the step of bringing the bitumen emulsion, preferably the stabilized bitumen emulsion, into contact with the silica sol or gel at substantially neutral pH makes it possible to initiate the homogeneous mineralization of the bitumen drops with the silicon oxide.

At the end of the step of bringing into contact, in the substantially neutral aqueous phase, the bitumen emulsion and the silica sol or gel previously prepared, a bitumen suspension is obtained.

The solid bitumen material according to the invention is obtained in a single step simultaneously combining, by means of a spray-dryer, the mineralization and the drying of the bitumen suspension.

The term “homogeneous mineralization” is intended to mean that the bitumen drop has a layer of silicon oxide on at least 90% of its surface, preferably on at least 95% of its surface, more preferentially on at least 98% of its surface.

In the process described below, some steps must imperatively be carried out before other steps, whereas for other steps, the order indicated may be reversed. For example, step a) can be carried out after step b), or extemporaneously with the performing of step b).

Step a): the Emulsion of Bitumen in the Aqueous Phase

During step a) of the process according to the invention, an emulsion of bitumen drops in an aqueous phase is prepared.

Bitumen is a heavy product which can come from various origins. In the present invention, the expression “bitumen” comprises bitumens of natural origin, synthetic bitumens and modified bitumens, and also mixtures thereof. Among bitumens of natural origin, mention may be made of those contained in natural bitumen deposits, natural asphalt deposits or tar sands. Synthetic bitumens can be selected from bitumens originating from crude oil refining, for example during atmospheric and/or vacuum distillation of oil. These bitumens can optionally be blown, visbroken and/or deasphalted. Synthetic bitumens can also be obtained by mixing various refining effluents, such as deasphalting products, visbreaking residues, blowing products and/or natural asphalt, by optionally combining them with the above distillation residues. Bitumens may be hard grade bitumens or soft grade bitumens. It is also known practice to modify the bitumen (or the bitumen mixture) by mixing therewith at least one compound for the purpose of improving some of its mechanical and thermal performance levels. The modified bitumens may be bitumens that have been fluxed by addition of volatile solvents, or fluxing agents of oil origin and/or fluxing agents of plant origin. Conventionally, the fluxing agents used can comprise C₆ to C₂₄ fatty acids in acid, ester or amide form in combination with a hydrocarbon-based fraction.

The modified bitumens may also be bitumen/polymer mixtures. By way of examples of polymers for bitumen, mention may be made of elastomers such as the copolymers SB (copolymer comprising styrene and butadiene blocks), SBS (styrene-butadiene-styrene block copolymer), SIS (styrene-isoprene-styrene copolymer), SBS* (star-shaped styrene-butadiene-styrene block copolymer), SBR (styrene-butadiene-rubber copolymer) or EPDM (ethylene-propylene-diene modified copolymer), polychloroprene, polynorbornene and optionally polyolefins such as polyethylenes PE (polyethylene) or PP (polypropylene), plastomers such as EVA (polyethylene-vinyl acetate copolymer) or EMA (polyethylene-methyl acrylate copolymer), copolymers of olefins and of unsaturated carboxylic esters, such as EBA (polyethylene-butyl acrylate copolymer), polyolefin elastomer copolymers, polyolefins of the polybutene type, copolymers of ethylene and of acrylic, methacrylic acid esters or of maleic anhydride, copolymers and terpolymers of ethylene and of glycidyl methacrylate, ethylene-propylene copolymers, rubbers, polyisobutylenes, SEBS (copolymer of styrene, of ethylene, of butylene and of styrene), ABS (acrylonitrile-butadiene-styrene).

Other additives may be added in order to modify the mechanical characteristics of a bitumen. These are for example vulcanizing agents and/or crosslinking agents capable of reacting with a polymer, when it is an elastomer and/or a plastomer, that can be functionalized and/or can comprise reactive sites.

Among the vulcanizing agents, mention may be made of those based on sulfur and derivatives thereof, used to crosslink an elastomer at contents of from 0.01% to 30% by weight relative to the weight of elastomer. Among the crosslinking agents, mention may be made of cationic crosslinking agents such as carboxylic monoacids or polyacids or anhydrides, carboxylic acid esters, sulfonic, sulfuric or phosphoric acids, or even acid chlorides, or phenols, at contents of from 0.01% to 30% by weight relative to the weight of the polymer.

These agents are capable of reacting with the functionalized elastomer and/or plastomer. They can be used in addition to or as a replacement for the vulcanizing agents. Among the additives that can be used, mention will be made of additives known to those skilled in the art, such as siccatives capable of ensuring increased cohesion over time of the fluxed binder and additives which make it possible to emulsify the bitumen.

Mention will also be made of adhesion agents such as amines or polyamines and/or surfactants; waxes of animal, plant or hydrocarbon-based origin; paraffins such as polymethylene paraffins and polyethylene paraffins; fluxing agents such as oils based on animal and/or plant fats or hydrocarbon-based oils of petroleum origin; resins of plant origin, such as rosins; antifoam additives; detergent and/or anti-corrosion additives; lubrication additives or anti-wear agent; crystallization-modifying additives; additives which inhibit paraffin deposits; additives which lower the pour point; modifiers of the rheology at low temperature; antioxidants; metal passivators; acidity neutralizers; additives which make it possible to lower the mixing temperature of asphalts and bituminous mixes; additives which make it possible to improve the adhesion of bituminous binders to fillers and granules, such as polyisobutylene succinimides; acids such as polyphosphoric acid or diacids, in particular fatty diacids; vulcanization accelerators such as zinc 2-mercaptobenzothiazole, zinc dibutyldithiocarbamate or tetramethylthiuram monosulfide.

The preparation of an emulsion of bitumen in an aqueous phase has already been described in the prior art.

According to one preferred embodiment of the process of the invention, the bitumen emulsion is a stabilized emulsion of bitumen drops in an aqueous phase.

Depending on the bitumen to be emulsified, those skilled in the art with their general knowledge are able to determine the pH of the aqueous phase of the bitumen emulsion making it possible to obtain a stabilized emulsion of bitumen drops.

Advantageously, the bitumen emulsion is stabilized with surfactants.

Depending on the bitumen to be emulsified and on the surfactant(s) chosen, those skilled in the art, with their general knowledge, are able to determine the pH of the aqueous phase of the bitumen emulsion making it possible to obtain an emulsion of bitumen drops which is a stabilized emulsion of bitumen drops in an aqueous phase.

This type of emulsion has already been described in the prior art. For example, WO 2009/144544 or Boucard & al., Road Materials and Pavement Design, 2015, 16(1), p. 330-348, describes the preparation of a bitumen emulsion stabilized with a surfactant in aqueous solution, in particular in acidic aqueous solution.

According to one preferred embodiment of the process of the invention, step a) comprises at least:
a substep a′) consisting in preparing an emulsion of bitumen drops in an aqueous phase stabilized with surfactants,
a substep a″) consisting in adding an additional amount of surfactants to the bitumen emulsion prepared in substep a′).

Preferably, the surfactants added in step a″) are in aqueous solution.

The addition of an additional amount of surfactant in substep a″) makes it possible to aggregate the bitumen drops obtained in substep a′) with one another in order to control the size of the aggregates of bitumen drops in emulsion.

The surfactants used for preparing the emulsion of bitumen drops are preferably chosen from amphoteric, anionic, nonionic or cationic surfactants.

Preferably, the surfactants used for preparing the emulsion of bitumen drops are chosen from amphoteric, nonionic or cationic surfactants.

The cationic surfactants are advantageously salts of amine compounds chosen from alkylamine salts; polyamine salts; polyamidoamine salts; alkylamidopolyamine salts; alkylpropylenepolyamine salts such as N-tallow propylenepolyamine salts; imidazoline salts; quaternary ammonium salts such as alkyltrimethylammonium salts, for instance tetradecyltrimethylammonium bromide (TTAB), or alkylbenzyldimethyl-ammonium salts; and mixtures thereof.

Advantageously, the cationic surfactant is tetradecyltrimethylammonium bromide (TTAB).

The amphoteric surfactants are advantageously chosen from alkyl amino acids or betaines.

The nonionic surfactants are advantageously ethoxylated alkylphenols.

The anionic surfactants are advantageously chosen from carboxylates; fatty acids obtained from animal and plant fats, for instance sodium stearate, Tall oil (CAS No. 8002-264), or Tall oil derivatives, such as pine oil, for instance the resin Vinsol®; sulfonates; and mixtures thereof.

The amount of surfactant used in this step can range from 0.1% to 10% by weight relative to the total weight of the emulsion, preferably from 0.3% to 8%, more preferentially from 2% to 7%.

Preferably, the amount of surfactant is from 0.5% to 30% by weight relative to the weight of bitumen base, even more preferentially from 0.5% to 20%, more preferentially from 1% to 10%.

Preferably, according to this embodiment, the bitumen emulsion comprises little or no solid particles enabling stabilization of the emulsion, whether they are mineral or organic particles. In particular, preference is given to emulsions of bitumen in an aqueous phase which comprise less than 1.4% by weight of solid particles, relative to the total weight of bitumen base, even more preferentially less than 1.2%, better still less than 1%, and even more preferentially less than 0.5% by weight of solid particles, relative to the total weight of bitumen base.

According to another embodiment of the invention, the emulsion of bitumen in an aqueous phase is stabilized with solid particles. This type of emulsion, commonly known as “Pickering emulsion”, has already been described in the prior art. For example, patent application FR 2 852 964 describes the preparation of a bitumen emulsion by means of a solid mineral material having a particle size ranging from 10 nm to 5 μm. International application WO 2015/104518 describes a solid bitumen emulsion stabilized with a mixture of at least two types of solid particles.

According to this embodiment, the particles used may be mineral or organic particles. Among the mineral particles, the solid particles are preferably chosen from the group made up of particles of oxides, particles of hydroxides and particles of sulfates of silicon or of metals. More preferentially, the solid particles are chosen from the group made up of particles of silicon oxide, titanium oxide, zirconium oxide and iron oxide, and salts thereof such as silicates, and carbon particles. Among the organic particles, mention may in particular be made of polymeric particles, for example latex or cellulose particles, lignin particles.

Furthermore, according to one preferred embodiment, at least one surfactant compound is added to the aqueous medium before the reaction of the emulsion of bitumen drops with the silica sol or gel. The surfactant compound may be as defined above in step a). The concentration of surfactant compound in the medium may be between 1.5% and 10% by weight, more preferentially between 2% and 10% by weight, relative to the total weight of the aqueous medium.

In the process according to the invention, step a) which consists in preparing an emulsion of bitumen drops in an aqueous phase can be carried out by emulsifying, by means of mechanical stirring, an aqueous mixture comprising the aqueous solution, preferably the aqueous solution to which surfactants have been added, and the bitumen, The mechanical stirring devices well known to those skilled in the art, such as Emulbitume® and Atomix®, can be used. The bitumen can be preheated in order to reduce its viscosity, preferably at a temperature of between 100° C. and 180° C., preferably between 120° C. and 160° C., and more preferably between 140° C. and 160° C. An aqueous mixture comprising the aqueous phase, in particular the aqueous phase to which surfactants have been added, and bitumen can be obtained by pouring the hot bitumen into an aqueous composition comprising the emulsifying materials, in particular into an aqueous composition comprising the emulsifying and stabilizing materials, such as the surfactants. Preferably, the aqueous composition is preheated at a temperature of between 30° C. and 95° C. in order to prevent the liquid bitumen from immediately solidifying on contact with the aqueous phase.

At the end of this step a), an emulsion of bitumen drops in an aqueous phase is obtained. These drops can have a diameter ranging from 1 μm to 100 μm, preferably from 1 μm to 70 μm, and more preferably from 1 μm to 50 μm. The size of the solid bitumen particles can be adjusted in a manner known to those skilled in the art according to the desired size of the bitumen drops, in particular by adding surfactants and/or by stirring the emulsion so as to promote agglomeration of the drops.

The emulsion can have a weight content of bitumen ranging from 1% to 90% by weight, preferably from 10% to 80% by weight, and more preferably from 20% to 70% by weight, relative to the total weight of the emulsion.

The emulsion of bitumen drops obtained in step a) can be used as it is directly in step c).

Step b): Preparation of a Silica Sol or a Silica Gel Having a pH Ranging from 4 to 8

The silicon oxide precursor can be chosen from silicates, in particular silicates of metals, of alkali metals and of alkaline-earth metals.

Preferably, the silicon oxide precursor can be chosen from the group made up of sodium silicate, magnesium silicate, iron silicate, calcium silicate, potassium silicate, and mixtures thereof.

The silicon oxide precursor is advantageously sodium silicate.

The silica sol or gel is advantageously prepared by using from 15% to 25% by weight of silicon oxide precursor relative to the sum of the weights of the water and of the precursor.

The silica sol or silica gel is advantageously prepared by introducing the silicon oxide precursor into water. The mixture of water and silicon oxide precursor is then stirred until a homogeneous phase is obtained. The silica sol or gel thus obtained has a basic pH due to the presence of sodium hydroxide, in particular a pH greater than or equal to 11.

The silica sol or gel having a basic pH is subsequently neutralized by means of an acidic aqueous solution, having a pH of less than 2. In particular, the acidic aqueous solution is prepared using 37 vol % hydrochloric acid having a pH below 2. The amount of acidic aqueous solution is adjusted so as to obtain a silica sol or gel having a pH ranging from 4 to 8, advantageously a pH ranging from 5 to 7.

The reaction of the silicon oxide precursor in substantially neutral aqueous medium allows the formation of a sol which converts into a gel by maturation.

Step c): Bringing the Silica Sol or Gel and the Aqueous Bitumen Emulsion Into Contact

During this step c), the amounts of silica sol or gel and of aqueous bitumen emulsion are chosen such that the weight ratio between bitumen and the amount of 30 silicon oxide precursor(s) (used in step b)) is between 1 and 20, more preferably between 1 and 10.

Preferably, the amount of silica sol or gel, calculated in silicon oxide precursor(s) equivalent used in step c), is from 5% to 80% by weight of silicon oxide precursor(s) relative to the weight of bitumen, more preferentially from 30% to 60%.

The mixture is left to stir for a period of between 30 min and 48 h, preferably between 1 h and 24 h, more preferentially between 3 h and 16 h.

In order to promote the homogeneity of the reaction medium, stirring is preferably applied during step (c). This stirring is preferably mild but continuous and is not carried out by means of a blade, a magnetic bar, etc. The reaction medium can for example be placed in a rotary stirrer, in particular of roll or wheel type. For example, the stirring can be carried out by rolls having a diameter of cm at a speed of between 5 and 50 rpm, preferably between 10 and 30 rpm.

At the end of step c), a bitumen suspension is obtained.

Step d): Subject the Bitumen Suspension Resulting from Step c) to a Spray-Drying Treatment

The spray-drying carried out in step d) makes it possible to carry out, in a single step, the mineralization and the drying of the bitumen suspension.

The term “spray-dryer”, or “spray-drying tower” or “spray-drying chamber”, denotes the equipment for the spray-drying.

This spray-drying technique makes it possible to reduce the capillary forces applied, which may break the shell of the solid bitumen particles.

The spray-drying technique according to the invention has the advantage of providing a dried bitumen powder having good properties in terms of adhesiveness, thermal resistance and mechanical strength, and which is in the form of a very fine granular powder.

The spray-drying makes it possible to pulverize the bitumen suspension obtained in step c) into fine droplets in a vertical chamber in a stream of hot air in order to obtain a bitumen powder according to the invention and also to evaporate off the aqueous phase. Once the bitumen powder has been formed, it is entrained by a stream of air to a cyclone which makes it possible to separate the air from the bitumen powder according to the invention.

The drying may be complete or partial. Preferably, the drying is substantially complete drying, that is to say that the moisture content of the solid particles obtained at the end of step d) is less than or equal to 5% by weight relative to the total weight of the particles, even more preferentially less than or equal to 2% by weight relative to the total weight of the particles.

Preferably, the operating conditions are chosen so as to promote the formation of a continuous layer of silicon oxide coating.

Advantageously, the flow rate of the injected air in the spray-drying nozzles is between 3 and 20 l/minute and more advantageously between 5 and 12 l/minute.

Advantageously, the diameter of the spray-drying nozzle is between 0.6 mm and 1.2 mm, more advantageously between 0.8 mm and 1 mm.

Advantageously, the temperature of the air circulating in the vertical chamber of the spray-drying chamber is between 100 and 150° C., more advantageously between 120 and 140° C.

Advantageously, the rate of pumping of the bitumen suspension is between 20% and 50%, more advantageously between 20% and 35%.

Advantageously, the differential pressure over cyclone (DP cyclone) is between 10 and 45 mbar, more advantageously between 20 and 35 mbar.

Advantageously, the flow rate of air injected into the vertical chamber of the spray-drying chamber is between 0.2 and 1.2 m³/minute, more advantageously between 0.3 and 0.7 m³/minute.

At the end of step d), particles with a core/shell structure comprising a bitumen base core and a silicon oxide shell are formed. Solid particles formed from a core comprising bitumen and from an essentially inorganic shell are obtained.

### Solid Bitumen Material

The Solid bitumen material obtained or capable of being obtained by means of the process described above is also a subject of the present invention. Indeed, when the bitumen emulsion is an emulsion, preferably stabilized with surfactants, it comprises no, or substantially no, particles for stabilization thereof. The prior art processes for mineralizing in a step at very acid pH do not make it possible to form particles comprising a bitumen core and a silica-based envelope. This material is advantageous insofar as it constitutes a new solid form of bitumen. This material is a solid bitumen material comprising particles formed from a core comprising bitumen and an envelope or a shell.

This embodiment relates to bitumen-based core/shell particles coated with a silica-based shell or envelope, which comprise, in the bitumen base, less than 1.4% by weight of solid particles relative to the total weight of bitumen base, even more preferentially at most 1.2%, better still at most 1%, and even more preferentially at most 0.5% by weight of solid particles relative to the total weight of bitumen base.

The term “shell” is intended to mean a layer at least partially surrounding the bitumen core and comprising a homogeneous layer of silicon oxide obtained according to step d) of the process as described above.

Preferably, the term “shell” is intended to mean a layer at least partially surrounding the bitumen core and consisting of a homogeneous layer of silicon oxide obtained according to step d) of the process as described above.

The term “layer at least partially surrounding the bitumen core” is intended to mean a layer surrounding at least 90% of the surface of the core, preferably at least 95% of the surface of the core, more preferentially at least 99% of the surface of the core.

It is possible to distinguish a solid bitumen material comprising a shell owing to the distinctive particular appearance of the shell (homogeneous layer) using conventional analysis methods known to those skilled in the art, for example by electron microscopy.

Advantageously, the silicon oxide-based shell represents from 5% to 35% by weight relative to the total weight of the solid bitumen material obtained at the end of step d), preferentially from 5% to 30%, more preferentially from 10% to 25%. The low silica content of the materials of the invention makes it possible to prepare road bitumens by mixing with aggregates, the properties of which are barely affected by the presence of the silica.

The material of the invention is in powder form, optionally in aggregated powder form, preferably in fluid powder form. Preferably, the size of the particles or grains of powder is from 1 to 500 μm, even more advantageously from 5 to 300 μm, even better still from 10 to 200 μm. In a known manner, the size of the particles or grains of powder is evaluated by scanning electron microscopy (SEM) or by laser particle size analysis.

The residual moisture content in the material of the invention is preferably less than or equal to 5% by weight, even better still less than or equal to 3% by weight, and even more preferably less than or equal to 1% by weight, relative to the total weight of the material.

The solid bitumen material obtained, or capable of being obtained, by means of the process according to the invention is particularly advantageous since it has excellent thermal stability, up to high temperatures.

The term “thermal stability” is intended to mean the fact that the bitumen material retains its solid structure in powder form and does not adhere up to a temperature of less than or equal to 100° C., preferably less than or equal to 120° C., even better still up to a temperature of less than or equal to 150° C.

The solid bitumen material obtained or capable of being obtained by means of the process according to the invention is particularly advantageous since it has excellent compressive strength.

These properties make it possible to envision transporting this powdered bitumen in bags, in particular bags of a size greater than or equal to 100 kg, even better still of a size greater than or equal to 1000 kg, these bags being commonly known as “big bags”, in boxes of from 5 kg to 30 kg, or in drums of from 100 kg to 200 kg.

In addition, the tests have shown that the solid bitumen material according to the invention can be readily releasable at the time of the production of bituminous binder, It can therefore be used after its transportation in a conventional manner, without the need to adapt the processes using this material. The uses of this bitumen can for example be in the road application fields, in particular in the production of road binders such as hot bituminous mixes, cold bituminous mixes or surface coatings, and in the industrial application fields, for example in the production of internal or external coatings.

Uses of the Solid Bitumen Material:

Another subject of the invention also relates to the use of the bitumen material which is solid at ambient temperature according to the invention as a road binder.

The road binder can be used to produce bituminous mixes, in combination with 40 aggregates according to any known process.

Preferably, the bitumen which is solid at ambient temperature according to the invention is used for the production of bituminous mixes.

Bituminous mixes are used as materials for constructing and maintaining road foundations and the surfacing thereof, and also for carrying out any highway work. Mention may for example be made of surface coatings, hot bituminous mixes, cold bituminous mixes, cold-poured bituminous mixes, emulsion gravels, base layers, bonding layers, tie layers and running layers, and other combinations of a bituminous binder and of the road aggregate having particular properties, such as anti-rutting layers, draining mixes, or asphalts (mixture of a bituminous binder and aggregates of the sand type).

Another subject of the invention relates to a process for producing bituminous mixes comprising at least one road binder and aggregates, the road binder being chosen from the solid bitumens according to the invention, this process comprising at least the steps of:
heating the aggregates to a temperature ranging from 100° C. to 180° C., preferably from 120° C. to 160° C.,
mixing the aggregates with the road binder in a tank such as a mixer or a mixing drum,
obtaining bituminous mixes.

The process of the invention has the advantage of being able to be carried out without a prior step of heating the solid bitumen according to the invention.

The process for producing bituminous mixes according to the invention does not require a step of heating the solid bitumen material before mixing with the aggregates, since, in contact with the hot aggregates and under a mechanic shear effect, the bitumen which is solid at ambient temperature is released.

The bitumen which is solid at ambient temperature according to the invention as described above has the advantage of being able to be added directly to hot aggregates, without having to be melted prior to the mixing with the hot aggregates.

Preferably, the step of mixing the aggregates and the road binder is carried out with stirring, then the stirring is maintained for at most 5 minutes, preferably at most 1 minute, in order to make it possible to obtain a homogeneous mixture.

The bitumen material which is solid at ambient temperature according to the present invention is notable in that it enables the transportation and/or storage of road bitumen at ambient temperature under optimal conditions, in particular without there being any agglomeration and/or adhesion of the solid bitumen during its transportation and/or storage, even when the ambient temperature is high. Moreover, the coating layer of the particles breaks under the effect of the contact with the hot aggregates and the mechanical shear, and it releases the bitumen base. Finally, the presence of the coating layer in the mixture of road binder and aggregates does not degrade the properties of said road bitumen for a road application, compared with a bitumen base which is uncoated.

Process for transporting and/or storing and/or handling road bitumen

Another subject of the invention also relates to a process for transporting and/or storing and/or handling road bitumen, said road bitumen being transported and/or stored and/or handled in the form of bitumen particles which are solid at ambient temperature.

Preferably, the road bitumen is transported and/or stored at a high ambient temperature for a period of greater than or equal to 2 months, preferably greater than or equal to 3 months.

Preferably, the high ambient temperature is from 20° C. to 90° C., preferably from 20° C. to 80° C., more preferentially from 40° C. to 80° C. even more preferentially from 40° C. to 60° C.

The bitumen particles according to the invention have the advantage of retaining theft divided form, and therefore of being able to be handled, after storage and/or transportation, at a high ambient temperature. They in particular have the capacity to flow under theft own weight without creeping, which allows them to be stored in bag packaging, drum packaging or container packaging of any shapes and of any volumes, then to be transferred from this packaging to equipment, such as worksite equipment (tank, mixer, etc.).

The bitumen powder grains are preferably transported and/or stored in bulk in bags of 1 kg to 100 kg or 500 kg to 1000 kg commonly known as “Big Bags” in the road bitumen field, said bags preferably being made of a hot-melt material. They may also be transported and/or stored in bulk in boxes of 5 kg to 30 kg or in drums of 100 kg to 200 kg.

The various embodiments and variants, the preferences and the advantages described above for each of the subjects of the invention apply to all the subjects of the invention and can be taken separately or in combination.

Other objectives, features and advantages of the invention will emerge from the following examples, which are given purely by way of illustration and are in no way limiting,

### Experimental Section

### I—Materials and Methods

Paraffinic bitumen base of grade 160/220 (B1)
Paraffinic bitumen base of grade 70/100 (B2)
Surfactant: tetradecyltrimethylammonium bromide (TTAB) sold by the company Sigma Aldrich
Acid: the pH of the water was adjusted by means of a solution of hydrochloric acid at pH=1, this solution has been obtained from hydrochloric acid at 37% by volume.
Silica precursor: sodium silicate solution sold by the company Sigma Aldrich under the name “sodium silicate solution purum, ≥10% NaOH basis, ≥27% S10₂ basis”.

### II—Examples

Step a) Preparation of an Emulsion of Bitumen Drops in an Aqueous Phase:

Step a1) Preparation of an Emulsion of Bitumen Drops A1 in an Aqueous Phase:

The bitumen-in-water emulsion was prepared with an Emulbitume® colloidal mill. The apparatus is composed of two thermostatic containers: one for the aqueous phase at 40° C. and the other for the bitumen at 130° C. Two distinct circuits bring the phases to the Atomix a mixer in which the bitumen is dispersed in the aqueous phase. The flow rates are controlled so as to obtain an emulsion with a bitumen content of 65% by weight. A surfactant (TTAB) concentration of 4 kg/tonne of emulsion was added to the bitumen emulsion previously obtained.

0.1 g of TTAB dissolved beforehand in 6.9 g of demineralized water was then added to 9 g of the bitumen emulsion previously obtained. The whole mixture is transferred into a 15 ml tube which is then placed in a rotary device (wheel) at 20 rpm overnight.

The following composition A1 is obtained:

| | Starting material | | |
|---|---|---|---|
| | Bitumen base B1 | TTAB | Water |
| % by weight | 36.56 | 1.27 | 62.17 |

Step a2) Preparation of an Emulsion of Bitumen Drops A2 in an Aqueous Phase:

The bitumen-in-water emulsion was prepared with an Emulbitume® colloidal mill. The apparatus is composed of two thermostated containers: one for the aqueous phase at 40° C. and the other for the bitumen at 130° C. Two distinct circuits bring the phases to the Atomix® mixer in which the bitumen is dispersed in the aqueous phase. The flow rates are controlled so as to obtain an emulsion with a bitumen content of 69.5% by weight. A surfactant (TTAB) concentration of 4 kg/tonne of emulsion was added to the bitumen emulsion previously obtained.

0.3 g of TTAB dissolved beforehand in 6.95 g of demineralized water was then added to 8.75 g of the bitumen emulsion previously obtained. The whole mixture is transferred into a 15 ml tube which is then placed in a rotary device (wheel) at 20 rpm overnight.

The following composition A2 is obtained:

| | Starting material | | |
|---|---|---|---|
| | Bitumen base B1 | TTAB | Water |
| % by weight | 37.5 | 1.87 | 60.63 |

Step a3) Preparation of an Emulsion of Bitumen Drops A3 in an Aqueous Phase:

The protocol for preparing the emulsion of bitumen drops A2 described above is reproduced with the same amounts in order to prepare an emulsion of bitumen drops A3 in an aqueous phase using the bitumen base B2.

The following composition A3 is obtained:

| | Starting material | | |
|---|---|---|---|
| | Bitumen base B2 | TTAB | Water |
| % by weight | 37.5 | 1.87 | 60.63 |

Step b) Preparation of a Silica Sol or Silica Oxygen Gel from a Silicon Oxide Precursor

Step b1) Preparation of a Silica Sol or Gel from a Silicon Oxide Precursor

1.7 g of the silica precursor is added dropwise to 97.45 g of demineralized water with manual stirring. The solution thus obtained, which has a pH=11.4, is then acidified by adding 3 g of an acidic aqueous solution with a pH=1 so as to obtain a solution of silica sol or gel having a pH=6.

The following composition C1 is obtained:

| | Starting material | | |
|---|---|---|---|
| | | Acidic solution | Demineralized |
| | Silicates | at pH = 1 | water |
| % by weight | 1.66 | 2.94 | 95.40 |

Step b2) Preparation of a Silica Sol or Gel from a Silicon Oxide Precursor

2 g of the silica precursor are added dropwise to 120 g of demineralized water with manual stirring. The solution thus obtained, which has a pH=11, is then acidified by adding 6.15 g of an acidic aqueous solution with a pH=1 so as to obtain a solution of silica sal or gel having a pH=4.3.

The following composition C2 is obtained:

| | Starting material | | |
|---|---|---|---|
| | | Acidic solution | Demineralized |
| | Silicates | at pH = 1 | water |
| % by weight | 1.56 | 4.68 | 93.76 |

Step c) Mixing of the Emulsion of Bitumen Drops from Step a), with the Silica Sol or Gel from Step b)

Step c1) Mixing of the Emulsion of Bitumen Drops from step a), with the silica sol or gel from step b1):

7.81 g of the emulsion A1 obtained in step a1) were weighed and added dropwise to the solution C1 obtained in step b1), the whole mixture having been transferred into a 250 ml flask. In order to avoid any loss of material, 2 g of demineralized water were poured into the tricorn mixing flask in order to rinse it. The flask was then placed on rolls at 10 rpm for 16 hours. The composition of the flask is the following:

| | Starting material | | | |
|---|---|---|---|---|
| | Bitumen base B1 | TTAB | Silicates | Water |
| % by weight | 2.55 | 0.09 | 1.52 | 95.84 |

This step makes it possible to initiate the homogeneous mineralization of the bitumen drops with the silicon oxide.

Step c2), or c3), Respectively Mixing of the Emulsion of Bitumen Drops A2 from step a2) or A3 from step a3), with the silica sol or gel C2 from step b2):

15.2 g of the emulsion A2 obtained in step a2) or of the emulsion A3 obtained in step a3) were weighed and added dropwise to the solution C2 resulting from step b2), the whole mixture having been transferred into a 250 ml flask. In order not to lose any material, 6.3 g of demineralized water were poured into the tricorn mixing flask in order to rinse it. The flask was then placed on rolls at 10 rpm for 16 hours. The composition of the flask is respectively the following:

| Bitumen emulsion/ | Starting | Bitumen | | | |
|---|---|---|---|---|---|
| silica sol or gel | material | base | TTAB | Silicates | Water |
| A2/C2 | % by | 8.53 | 0.42 | 2.33 | 88.72 |
| | weight | (bitumen | | | |
| | | base B1) | | | |
| A3/C2 | % by | 8.53 | 0.42 | 2.33 | 88.72 |
| | weight | (bitumen | | | |
| | | base B2) | | | |

This step makes it possible to initiate the homogeneous mineralization of the bitumen drops respectively obtained in step a2) or in step a3) with the silicon oxide.

### Step d) of Simultaneous Mineralization and Drying of the Bitumen Suspension Obtained in Step

### Step d1) of Simultaneous Mineralization and Drying of the Bitumen Suspension Obtained in Step c1):

The bitumen suspension obtained in step c1) is then simultaneously mineralized and dried by means of a spray-dryer with the following experimental conditions:

Air flow rate in the spray-drying chamber: 0.3 m³/min

Air temperature in the spray-drying chamber: 120° C.

Differential pressure over cyclone (DP cyclone): 32 mbar

Bitumen emulsion pumping rate: 20%

Flow rate of injected air in the spray-drying nozzles: 7.2 l/min

Volume of the bitumen emulsion to be mineralized and dried: 112 g

Spray-drying nozzle diameter: 0.8 mm

The completely dried bitumen powder P1 is recovered.

### Step d2) or d3) of Simultaneous Mineralization and Tying of the Bitumen Suspension, Respectively Obtained Instep c2) or in Step c3):

The bitumen suspension, respectively A2/C2 obtained in step c2) or A3/C2 obtained in step c3), is then simultaneously mineralized and dried by means of a spray-dryer with the following experimental conditions:

Air flow rate in the spray-drying chamber: 0.3 m³/min

Air temperature in the spray-drying chamber: 120° C.

Differential pressure over cyclone (DP cyclone): 32 mbar

Bitumen emulsion pumping rate: 40%

Flow rate of injected air in the spray-drying nozzles: 12 l/min

Volume of the bitumen emulsion to be mineralized and dried: 112 g

Spray-drying nozzle diameter: 1 mm

The completely dried bitumen powders P2 (derived from A2/C2) and P3 (derived from A3/C2) are respectively recovered.

### II—Results

### Macroscopic and Microscopic Observations

With the spray-drying technique, very fine granular powders P1, P2 and P3 are obtained.

The powders were then characterized by scanning electron microscopy (SEM). The obtaining of grains with sizes between 10 and 200 μm is observed for the three powders P1, P2 and P3. Furthermore, the images make it possible to observe the presence of a thin layer of silica at the surface of the external drops of the grains of the powders P1, P2 and P3.

### Silica Content by Calcination

The calcination of the powder P1 shows that it contains 17.9% by weight of inorganic shell comprising silica.

The calcination of the powder P2 shows that it contains 19.5% by weight of inorganic shell comprising silica.

Mechanical Strength

Compression Test of Powder P1

In order to quantify the compressive strength of the powders in a big bag, under extreme storage conditions, the following protocol was applied: a crucible was filled with powder and then a compressive force of ˜8.1 kPa (which represents the force applied in a 1 tonne big bag) was applied to the powder at a temperature of 50° C. for several hours and the sample was then observed after compression.

It is first of all noted that the indenting device does not show any adhered bitumen. Furthermore, the compressed sample can be easily removed from the crucible and the powder P1 recovered easily returns to granular form.

Coating and Passive Adhesiveness Test on P1

37.4 g of aggregates were weighed and placed in a bowl in an oven at 160° C. 2.65 g of powder P1 were then weighed and placed in an oven at 160° C. Once the 2 constituents were at temperature, the powder was poured onto the aggregates and manual shearing with a spatula was applied. The bowl was placed in an oven at 160° C. and further shearing was applied until coated aggregates were obtained.

Passive Adhesiveness: The coated aggregates obtained from the powder P1 placed in water at 60° C. overnight. The result is very satisfactory since the bitumen did not withdraw from the aggregates.

Coating and Passive Adhesiveness Test on P3
1.2 kg of aggregates were weighed and placed in a bowl in an oven at 160° C., 64.25 g of powder P3 were then weighed and placed in an oven at 160° C. Once the two constituents were at temperature, the powder was poured onto the aggregates and manual shearing with a spatula was applied. The bowl was placed in an oven at 160° C. and further shearing was applied until coated aggregates were obtained.
Passive adhesiveness: The coated aggregates obtained from the powder P3 were placed in water at 60° C. over night. The result is very satisfactory since the bitumen did not withdraw from the aggregates.

1-13. (canceled)

14. A process for preparing a bitumen material which is solid at ambient temperature, this process comprising at least the steps consisting in:
a) preparing an emulsion of bitumen drops in an aqueous phase,
b) preparing a silica sol or a silica gel from a silicon oxide precursor at a pH ranging from 4 to 8,
c) bringing the emulsion of bitumen drops from step a) into contact with the silica sol or silica gel from step b),
d) subjecting the bitumen suspension resulting from step c) to a spray-drying treatment.

15. The process as claimed in claim 14, wherein the material is in the form of particles comprising a core and a coating layer.

16. The process as claimed in claim 15, wherein the material is in the form of particles comprising a core and a coating layer, in which:
the core comprises at least one bitumen base,
the coating layer is silica-based.

17. The process as claimed in claim 16, wherein the bitumen material has a layer of silicon oxide on at least 90% of its surface.

18. The process as claimed in claim 14, wherein the material comprises from 5% to 35% by weight of silica relative to the total weight of the material.

19. The process as claimed in claim 14, wherein the material is in powder form

20. The process as claimed in claim 14, wherein the silicon oxide precursor is chosen from silicates.

21. The process as claimed in claim 20, wherein the silicon oxide precursor is chosen from the group made up of sodium silicate, magnesium silicate, iron silicate, calcium silicate, potassium silicate, and mixtures thereof.

22. The process as claimed in claim 14, wherein the bitumen emulsion in step a) is a stabilized emulsion of bitumen drops in an aqueous phase.

23. The process as claimed in claim 22, wherein the bitumen emulsion in step a) is stabilized with a surfactant or a mixture of surfactants chosen from amphoteric, nonionic, anionic and cationic surfactants.

24. The process as claimed in claim 23, wherein the bitumen emulsion from step a) is stabilized with a cationic surfactant chosen from: a salt of an amine compound chosen from alkylamine salts; polyamine salts; polyamidoamine salts;
alkylamidopolyamine salts; alkylpropylenepolyamine salts; imidazoline salts;
quaternary ammonium salts; and mixtures thereof.

25. The process as claimed in claim 14, wherein the drops of the bitumen emulsion from step a) have a diameter ranging from 1 μm to 100 μm.

26. The process as claimed in claim 25, wherein the drops of the bitumen emulsion from step a) have a diameter ranging from 1 μm to 70 μm.

27. The process as claimed in claim 26, wherein the drops of the bitumen emulsion from step a) have a diameter ranging from 1 μm to 50 μm.

28. The process as claimed in claim 14, wherein, in step b), the pH of the aqueous phase is adjusted to a value ranging from 5 to 7.

29. The process as claimed in claim 14, wherein, in step c), the pH of the aqueous phase has a value ranging from 5 to 7.

30. The process as claimed in claim 14, wherein the bitumen from step a) comprises less than 1.4% of solid particles by weight relative to the total weight of bitumen base.

31. A process for producing bituminous mixes, this process comprising a step of producing solid bitumen as claimed in claim 14, and a step of mixing the aggregates with the solid bitumen.

32. The process as claimed in claim 31, for producing bituminous mixes comprising at least one road binder and aggregates, the road binder being chosen from solid bitumens, this process comprising at least the steps of:
producing solid bitumen, this process comprising at least the steps consisting in:
a) preparing an emulsion of bitumen drops in an aqueous phase,
b) preparing a silica sol or a silica gel from a silicon oxide precursor at a pH ranging from 4 to 8,
c) bringing the emulsion of bitumen drops from step a) into contact with the silica sol or silica gel from step b),
d) subjecting the bitumen suspension resulting from step c) to a spray-drying treatment;
heating the aggregates to a temperature ranging from 100° C. to 180° C., preferably from 120° C. to 160° C.,
mixing the aggregates with the road binder,
obtaining bituminous mixes.

33. The process as claimed in claim 32, which does not comprise a step of heating the road binder before it is mixed with the aggregates.
